(19) United States
(12) Patent Application Publication
(10) Pub. No.: US 2006/0293497 A1
(43) Pub. Date: Dec. 28, 2006

(54) Articles of manufacture made from polyamide resins and suitable for incorporation into LED reflector applications

(76) Inventors: Marvin M. Martens, Vienna, WV (US); Georgios Topoulos, Geneva (CH)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/449,106

(22) Filed: Jun. 8, 2006

Related U.S. Application Data
(60) Provisional application No. 60/689,774, filed on Jun. 10, 2005.

(51) Int. Cl. C08G 69/08

(52) U.S. Cl. 528/310

(57) ABSTRACT

Articles useful in light emitting diode assemblies are disclosed which are made from polyamide resin compositions and optionally fillers and/or additives. These articles possess superior mechanical properties along with low moisture absorption, and are well suited to LED applications.

### CROSS REFERENCE TO RELATED APPLICATIONS

This application claims the benefit of priority to U.S. Provisional Application No. 60/689,774, filed Jun. 10, 2005.

### FIELD OF THE INVENTION

The present invention relates to a variety of articles manufactured using polyamide resin compositions and which are uniquely suitable for uses incorporating light emitting diodes or so-called “LED's”. More specifically the present invention relates to any of a variety of substrates, surfaces, housings and the like made from the polyamide resin compositions disclosed herein and to which are affixed or secured LED's, whereby such substrates and the like offer superior reflectivity and low water absorption properties.

### BACKGROUND OF THE INVENTION

It is widely known and appreciated that polyamide resins such as polyamide 6,6 and polyamide 6 are very strong resins well suited for the molding of various articles. In general polyamide resin compositions offer excellent fluidity during conventional molding processes, making them the material of choice for a wide spectrum of molding applications. Moreover polyamide compositions have been tailored to suit any of a number of demanding applications requiring exceptional mechanical characteristics, heat resistance, chemical resistance and/or dimensional stability when moisture is absorbed. It is not surprising then that polyamides enjoy a wide range of applications, including parts used in automobiles, electrical/electronic parts, and furniture.

As parts of electrical/electronic products, such as sealants for connectors, coil bobbins and so forth it is possible to make use of polyamide resin compositions. For these sealants, in addition to the high solder heat resistance, the parts should have a small thickness to reduce the overall weight of the parts. As nylon 66 has good fluidity, it is able to flow through the narrow gaps in the molding dies, so that thin-wall moldings can be formed. On the contrary, the solder heat resistance is poor. Moreover, nylon 6,6 shows variations in dimensions and properties as moisture is absorbed. Consequently, it is necessary to predict these variations and to take the appropriate measures in designing the parts. Because their applications are limited, and they are inappropriate for manufacturing high-precision parts. These are serious disadvantages.

Moreover, severe limits are encountered when polyamide resins are selected for higher temperature applications such as those in conjunction with LED's. For example, it is not uncommon for materials incorporating nylon 6 and nylon 66 when so deployed to exhibit an increased tendency to absorb moisture, and with this undesirable dimensional changes. Also, stress cracks may form during the service life of parts made therefrom. Still other problems exist with reinforced materials such as glass fiber reinforced nylon 66, in which the aforementioned moisture absorption affects both dimensional variation and degradation. These problems are even more pronounced when nylon 6 is used.

Accordingly, it is an object of the invention to provide articles associated with LED components (such as housings, reflectors, reflector cups, scramblers and the like) and made from a polyamide composition which demonstrates excellent fluidity in the molding operation. A further object of the invention is to provide such a polyamide resin composition suitable for molding these components and having excellent mechanical characteristics, heat resistance, chemical resistance and dimensional stability upon moisture absorption. A feature of the invention is its versatility for use in a wide range of applications in this field. It is an advantage of the invention to provide articles made from this composition which have as attributes resistance to blistering, discoloration and heat aging; and better reflectability; and further that such articles can withstand soldering operations. These and other objects, features and advantages of the present invention will become better known and understood upon having reference to the following description of the invention.

### SUMMARY OF THE INVENTION

There is disclosed and claimed herein a component of a light emitting diode assembly, the component comprising a polyamide resin comprising a polyamide prepared by polymerizing one or more diamines and one or more dicarboxylic acids;

(a) wherein about 50 to about 100 mole percent of said one or more diamines is at least one aliphatic diamine having from 10 to 20 carbon atoms and further wherein about 0 to about 50 mol percent of said one or more diamines is at least one aliphatic diamine having from 4 to 9 carbon atoms but other than 1,9-diaminononane;
and
   (b) wherein about 50 to about 100 mol percent of said one or more dicarboxylic acids is terephthalic acid and further wherein about 0 to about 50 mole percent of said one or more dicarboxylic acids is at least one aromatic acid other than terephthalic acid and/or at least one aliphatic dicarboxylic acid having from 4 to 20 carbon atoms.

### DETAILED DESCRIPTION OF THE INVENTION

Light emitting diodes are widely used in a variety of electronics applications where bright lighting is desirable. In these applications the LED is typically attached to a substrate and positioned within or along a reflective surface so that its lighting characteristics are enhanced and directed in a desirable manner. LEDs have recently been the subject of renewed attention with the recent development of blue light in these applications. Inasmuch as previous applications incorporated light emitting diodes of red and green, the addition of blue light greatly expands the role and possible applications of LEDs.

However the materials used in conjunction with LEDs typically face demanding challenges in electronics applications, largely due to the poor adhesive qualities of sealing materials, undesirable moisture absorption associated with conventional materials, and the like. Accordingly, there is disclosed and claimed herein polyamide resins offering superior mechanical properties combined with low moisture absorption, an effective combination for use of such materials in LED applications.

The Polyamide

The polyamides used in the present invention as claimed herein generally have a melting point of greater than about 280 C. and less than about 330 C., especially greater than 295 C. In addition, the polyamide is preferably a partially crystalline polymer having, generally, a molecular weight of at least 5,000. In some embodiments, the polyamide has a heat of fusion of greater that 17 J/g. the inherent viscosity (“IV”) is typically 0.8 dl/g to 1.2 dl/g, as measured at 23 C. in m-cresol or concentrated sulfuric acid.

In the polyamides of the present invention the amounts of the one or more dicarboxylic acids and the one or more diamines are preferably substantially complementary on a molar basis, as will be appreciated by persons skilled in the art. Representative acids useful in this invention include isophthalic acid and dodecanedioic acid, while representative diamines include 10-diamine and 12-diamine. An excess of acids or diamines, especially the latter, can be used depending on the desired characteristics of the polyamide and the nature and extent of side reactions that may produce volatile or other matter. As is known, diamines tend to be more volatile than carboxylic acids and thus it may be desirable to use an excess of diamine.

Fillers

Further, for the polyamide resin composition of this invention, inorganic fillers can be incorporated. Such fillers typically include glass fibers, carbon fibers, calcium titanate, whiskers, kaolin, talc, mica, etc. If it is necessary to increase the mechanical strength of the molding, it is preferable to add glass fibers. If it is necessary to increase the dimensional stability of the molding and to suppress warpage, kaolin, talc, mica or glass flakes may be added.

There are no specific limitations as to the type and concentration of fillers that can be used in blend compositions of the present invention. Preferred filler types are inorganic fillers such as glass fibers and mineral fillers or mixtures thereof. The concentration of fillers in the filled composition can be selected according to the usual practice of those having skill in this field.

Other Additives

The compositions of the present invention can contain one or more additives known in the art, such as UV stabilizers and antioxidants, lubricants, flame retardants and colorants, as long as these additives do not deleteriously affect the performance of the polyamide composition. In addition, for the polyamide resin composition of the invention, as long as the characteristics of the obtained molding are not degraded, other additives, such as plasticizers, oxidation inhibitors, dyes, pigments, mold release agents, etc may be added in appropriate amounts in addition to the aforementioned polyamide and inorganic filler.

Processes for Preparation

The compositions of the invention may be prepared by blending the polyamide and filler and then melt compounding the blend to form the composition. Such melt compounding may be carried out in single screw extruders equipped with suitable mixing screws, but is more preferably carried out in twin screw extruders.

The polyamide can be made by methods known in the art. For example, a polyamide can be prepared by a process comprising the steps of:
(a) feeding to a reactor an aqueous salt solution of an admixture of carboxylic acid and diamine;
(b) heating the aqueous salt solution under pressure until the pressure in the reactor reaches at least about 1300 kPa, with water (in the form of steam) and other volatile matter being vented from the reactor;
(c) when the temperature of the reaction mixture has reached a temperature of at least about 270 C, preferably 280-320 C, reducing the pressure in the reactor to atmospheric pressure over a period of at least 15 minutes in a manner that avoids excessive foaming of the reaction mixture;
(d) maintaining the reaction mixture at a pressure that is not greater than about atmospheric pressure, preferably under vacuum, until the polyamide formed has reached a predetermined molecular weight; and
(e) discharging the polyamide from the reactor.

It will be understood by persons skilled in the art, that the polyamide used in the present invention can also be manufactured using solid phase polymerization, extrusion polymerization, continuous polymerization, and the like.

Methods of production of the polyamide are well known in the art. For example, the polyamide resin(s) can be produced by condensation of equimolar amounts of saturated dicarboxylic acid with a diamine. Excess diamine can be employed to provide an excess of amine end groups in the polyamide. It is also possible to use in this invention polyamides prepared by the copolymerization or terpolymerization.

Preferably, to avoid excessive polymer degradation during compounding and injection molding, all polymer preblends and compounded blends should be pre-dried to a moisture content below about 0.05%. The ingredients are then mixed in their proper proportions in a suitable vessel such as a drum or a plastic bag. The mixture is then melt blended, preferably in a single or twin screw extruder, at a melt temperature, measured at the exit of the extruder die, preferably in the range of about 310 C to 370 C when working with polyamides with meltpoints above 280 C. Melt temperatures significantly above 370 C, generally, should be avoided to keep degradation of the polyamide to a minimum. It will be understood by persons skilled in the art that the appropriate melt temperature can be determined easily, without undue experimentation.

For good dispersion of all components, it is preferable to use a twin screw extruder with appropriate screw design, although single screw extruders are suitable as well. Appropriate screw design can also be easily determined, without undue experimentation, by persons skilled in the art. Moreover for preparing the moldings of the present invention, various conventional molding methods may be adopted, such as compression molding, injection molding, blow molding and extrusion molding. Also, depending on the demand, it is possible to post process the molding to form the product.

End Uses

The compositions of the present invention can be used in the manufacture of a wide variety of components of LED assemblies using melt processing techniques, where such components encounter temperatures that are higher than those typically used with other polyamide compositions and especially products requiring a smooth, glossy surface. The compositions of the present invention can also be formed into films and sheets unique to LED applications. These compositions find utility in LED end uses where retention of properties at elevated temperatures is a required attribute.

### EXAMPLES

The moisture absorptivity of compounded samples of materials of the instant invention are compared against that of conventional materials, namely polyamide 6T/66 and polyamide 9T, in the table below. It is noted that the tensile strength, elongation, and notched izod test results of the polyamide 10T/1012 compares favorably to those of the polyamide 6T/66 and polyamide 9T. However, the moisture absorptivity of the 10T/1012 is desirably less than the other materials.

In these examples the following materials were used: 6T/66 (55/45 molar ratio); 9T/˜8T (85/15 molar ratio); and 10T1012 (90/10 molar ratio). Further the terms “reflow” and designations “standard or“+15 C” are used. Since blistering temperature is highly affected by the oven type, temperature profile, sample mounting, and the like a standard polymer was processed as a base case. The 6T/66 sample provides a blistering temperature on the particular equipment and setup. The reference blistering temperature will vary from setup to setup, and it is not uncommon to get a 10 C higher value in other tests conducted independently than what was measured here, depending on the oven used. Therefore whatever blistering temperature is recorded on the standard 6T/66 material becomes the “standard case”. Thereafter the delta value from that standard case is recorded for the other materials. In this example, the 10T/1012 resulted in a blistering temperature 15 C higher than the 6T/66.

The polyamide resin compositions were injection molded with injection pressure 1000 kg/cm2, with cylinder temperature established at a temperature of 10° C. higher than the melting point of the resins and at die temperature of 120° C., and test pieces of 64 mm long, 6 mm wide, 0.8 mm thick were obtained. These test pieces were stored and allowed to absorb water in a thermo-hygrostat room of 40° C. and relative humidity OF 95 %. After being left to absorb water for 168 hours, the weight of each test piece was measured with precision balance. The amount of water absorption measured in weight percent was determined by following equation:
M=(M2−M1)/M1×100

M: amount of water absorption (wt. %), M1: absolute dry weight of the test piece (g), M2: test piece weight after water absorption (g).

| | | 6T/66 | 9T | 10T/1012 |
|---|---|---|---|---|
| TENSILE STRENGTH | MPa | 183 | 164 | 170 |
| ELONGATION | % | 1.8 | 2.0 | 1.8 |
| NOTCHED IZOD | KJ/m2 | 14.4 | 12.7 | 14.6 |
| MOISTURE | % | 2.4 | 1.1 | 0.9 |
| ABSORPTION | | | | |
| (168 HRS, 95% RH, | | | | |
| 40 C.) | | | | |
| REFLOW | | STANDARD | +15 C. | +15 C. |

1. A component of a light emitting diode assembly comprising a polyamide resin comprising a polyamide prepared by polymerizing one or more diamines and one or more dicarboxylic acids; wherein (a) about 50 to about 100 mole percent of said one or more diamines is at least one aliphatic diamine having from 10 to 20 carbon atoms and further wherein about 0 to about 50 mol percent of said one or more diamines is at least one aliphatic diamine having from 4 to 9 carbon atoms but other than 1,9-diaminononane;and further wherein (b) about 50 to about 100 mol percent of said one or more dicarboxylic acids is terephthalic acid and further wherein about 0 to about 50 mole percent of said one or more dicarboxylic acids is at least one aromatic acid other than terephthalic acid and/or at least one aliphatic dicarboxylic acid having from 4 to 20 carbon atoms.

2. The component of claim 1 selected from the group consisting of housings, reflectors, reflector cups, and scramblers.

3. The component of claim 1 further comprising less than about 10 weight percent of an inorganic filler.

4. The component of claim 3 wherein said filler is selected from glass fibers and glass flakes.

5. The component of claim 3 further comprising one or more additives.

6. The component of claim 5 wherein said one or more additives are independently selected from the group consisting of UV stabilizers and antioxidants, lubricants, flame retardants and colorants.
